(19) United States
(12) Patent Application Publication
(10) Pub. No.: US 2015/0248814 A1
(43) Pub. Date: Sep. 3, 2015

(54) TEAM POKER SEATING PROTOCOL METHOD AND SYSTEM

(71) Applicant: Glyn Mason Ottofy, Las Vegas, NV (US)

(72) Inventor: Glyn Mason Ottofy, Las Vegas, NV (US)

(21) Appl. No.: 14/708,764

(22) Filed: May 11, 2015

(51) Int. Cl. G07F 17/32

(52) U.S. Cl. CPC G07F 17/3241; G07F 17/3276; G07F 17/3293

(57) ABSTRACT

A structured process creating a modified random seating protocol designed for team gaming, table tournaments, that does not allow players from the same team to play on the same gaming table while there is an opponent at the table, thus eliminating collusion among teammates. The seating protocol method provides an initial seating assignment, and consolidation of tables, that does not allow teammates to play together until, and unless, teammates are the only players left in the event. After no further consolidation can take place without teammates on the same table, the tables play as single table tournaments (STT). Until further consolidation can take place, teammates play heads-up against a teammate, or they play among themselves for individual finish position. Teammates may have to wait for a STT to finish before consolidating. The seating protocol provides the structure that ensures there is no “slow playing” or “chip dumping”, among teammates with opponents at the table.

### CROSS-REFERENCE TO RELATED APPLICATIONS

None.

### FEDERALLY SPONSORED RESEARCH

None.

### SEQUENCE LISTING

None.

### REFERENCES

(1) PokerTDA.com: Current Tournament Directors Association Rules, Rule: 61 Ethical Play. These tournament rules represent the current standard in poker industry.

(2) U.S. Pat. No. 7,819,735 Ottofy.

(3) U.S. Pat. No. 6,142,872 Walker et al.

### BACKGROUND AND PRIOR ART OF THE INVENTION

Gaming tournaments and events such as poker tournaments are very popular forms of social networking, entertainment, and gambling. Games are being played online and in casinos 24×7 year around. The poker industry has a huge market in the US and Worldwide.

The poker industry has developed standard rules that specifically state that, [See Reference (1)]: “Poker is an individual game. Soft play will result in penalties, which may include forfeiture of chips and/or disqualification. Chip dumping and/or all other forms of collusion will result in disqualification.” These rules are used in all major World poker tournaments including the largest live event, the World Series of Poker™.

This rule stated in other terms means: “team play poker” in a single event is not recognized as ethical way to play poker. Team Poker® is not allowed in poker tournaments, as it by definition, is ‘collusion’, in their opinion. The team gaming patent, See Reference (2) System and Method for Playing a Team Gaming Tournament, becomes non-workable for serious card play by the highest authority in the field, the Tournament Directors Association. Still others in the field see the potential of team play card games and look for options and alternatives to implement team play in a fair and ethical way.

The Team Gaming Consolidation Seating Protocol provides a tournament method that allows team play while preventing collusion, thereby enabling “team play poker,” a new and entertaining variant of the game which will broaden the market. The protocol simply stated is, that teammates, may not sit on the same table with opponents. In other words, teammates cannot sit at a table when their team's opponents are also seated at the same table (i.e. “no teammate contact”; or, NO-CONTACT TEAM POKER). The Team Gaming “NO-CONTACT RULE” provides this by creating a modified random seating protocol. Randomness is modified only to not allow teammates to play on the same table until they are heads-up, or the only players left in the tournament.

The no-contact seating protocol provides the methods and process that overcomes the “collusion potential” in team gaming consolidation tournaments. Teammates can consolidate to the same table to play heads-up, or when there are no other opponents left in the event. Since teammates are never sitting on tables with opponents there is no potential of “soft-play”, “chip-dumping”, with opponents seated on the table.

Therefore, a team tournament like the patented, Reference (2), Team Gaming System in conjunction with, and using, the seating assignment system are “ethical” because there is no potential of collusion. The team gaming methods as presented in Reference (2) patent, can be executed without collusion, within the structure of a single team gaming tournament. Tournament directors can easily structure team games with this system. Tournament directors can offer league team play, and provide their players the excitement, synergism, and comradery that only team dynamics can provide. The art is advanced by the, “no-contact”, Team Gaming Seating Protocol.

The Walker patent, See Reference (3), which address' team play does not address “seating protocol” as a claim, and therefore is not infringed by this new art. No other invention was found addressing the issue of team play and collusion in a single tournament event.

In live casinos or online, the tournament directors structured games are managed, whole or in part, by the current art of automated and semi-automated computer systems. These computer systems do the seat assignments, and or, help, or fully execute the tournament consolidation seating protocol. The method and system for executing the, “No-Contact”, Team Gaming Consolidation Protocol offers a design to automatically, or directly support team gaming protocol. Of course in live games, with the potential for human error, the seating protocol responsibility rest not only with tournament director and staff, but also, the players in the event. Players can receive penalties including ejection from the tournament for not identifying conflicts with the “no-contact” protocol.

### SUMMARY OF THE INVENTION

An object of the present invention is to provide a new seating method for playing team gaming tournaments. The new seating system makes it impossible for teams to collude. Therefore, by the industry standard, any team play using this system is playing “ethically”, and “fair”, team play because there is no chance of collusion among teammates. This team gaming seating protocol provides the modified random consolidation method that allows “ethical” team composite scoring [e.g. See Ref. (2) for a team gaming scoring method] in a single or multiple tournament events. With this invention tournament directors can structure their tournaments and prize pool awards for both individuals and teams, thereby addressing a broader and more entertaining market segment. Tournament directors know, when using The Team Gaming Consolidation Seating Protocol (aka the Team Gaming “No-Contact” Rule), there is no possibility of collusion among teammates.

It is a further object of the present invention to provide the team gaming seating protocol over a computer network. The network includes server capabilities, and a plurality of end-user computers coupled to the server via a network connection; wherein, the end-user computer has a graphical display portion adapted to display a browser window.

The team gaming tournament seating protocol can be displayed in the browser window. A plurality of users can form a plurality of teams of one or more users, to play in the gaming tournament, and be seated and tables consolidated by sending user input from the plurality of users to the server, with the server executing seating assignments. The computer software object design provides the interface and protocol to execute the team gaming, “no-contact”, seating protocol automatically as player/teams register and bust out of tournaments.

In live card room play the object of the present Invention is to provide the seating protocol on a ‘real time’ graphic display to direct the team gaming “no-contact” rule. Feedback for the computerized seating protocol system collects data for the tables and notifies tournament director management when it is time to consolidate, and a modified random seating draw is provided. The randomness of the consolidation draw takes into account the “no-contact” constraint and issues new seating assignments to the players on the tables being consolidated.

It is yet a further object of the present invention to provide server and software design for providing a team gaming seating protocol. The server having memory and a processor to execute the memory of program instruction for a computer gaming tournament that allows users the opportunity to form teams, be seated, and play. The object system provides initial seating, and seating consolidation throughout the event that does not allow teammates to play on the same table with each other until they are heads-up, or they are the only players left.

### BRIEF DESCRIPTION OF THE DRAWINGS

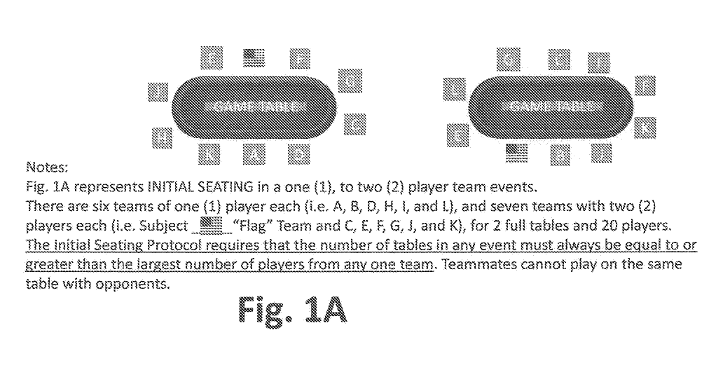

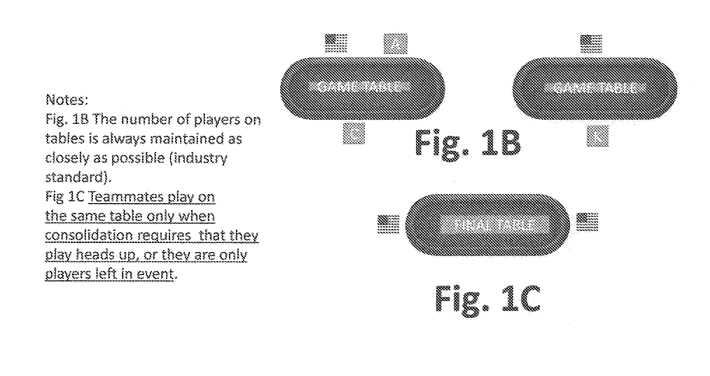

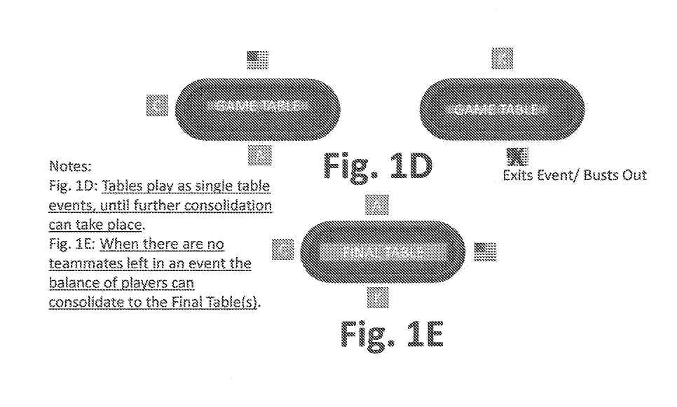

### FIGS. 1-5

FIG. 1 (FIG. 1A through 1E) are examples of 1 to 2 persons per team events showing method on “no-contact” Team Gaming Consolidation.

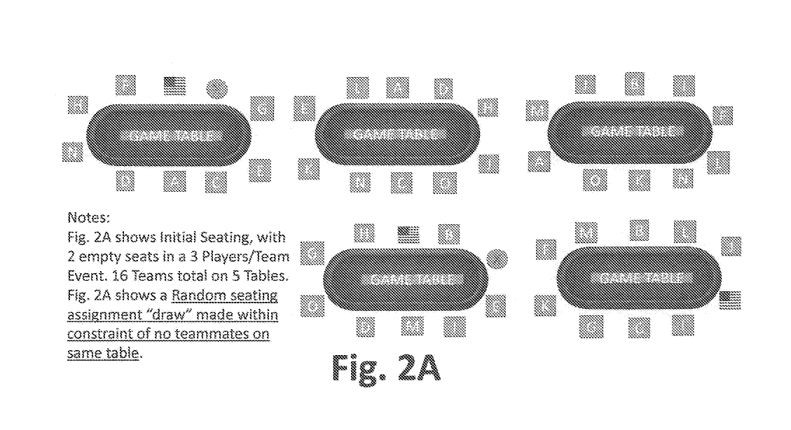

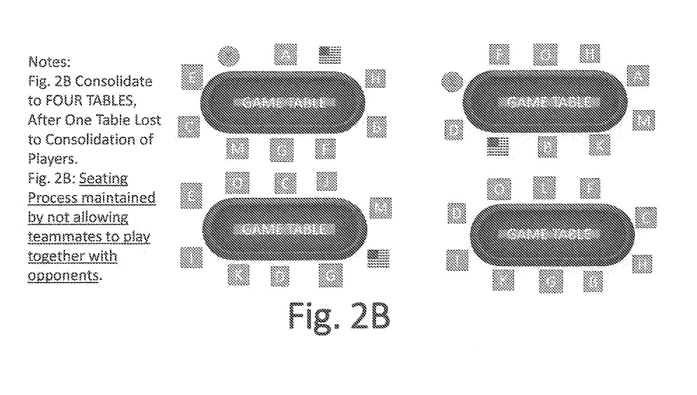

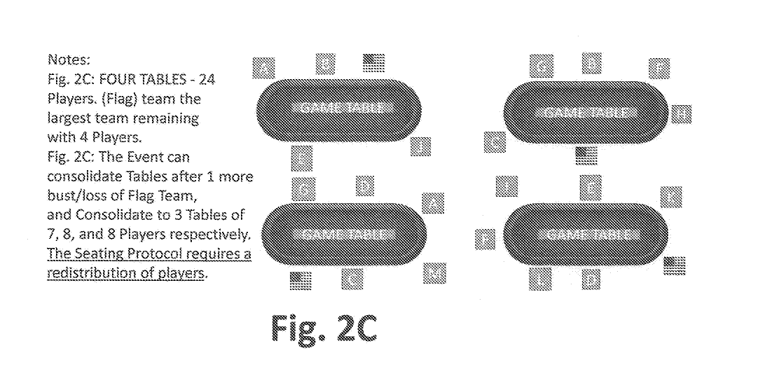

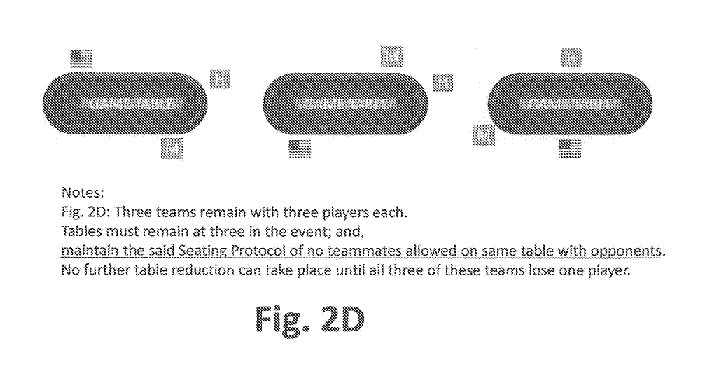

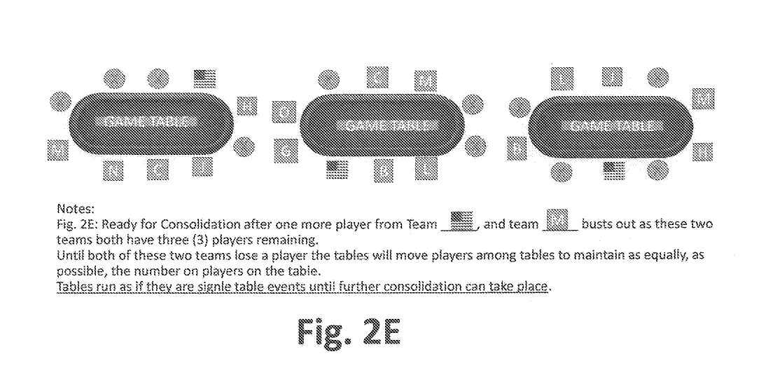

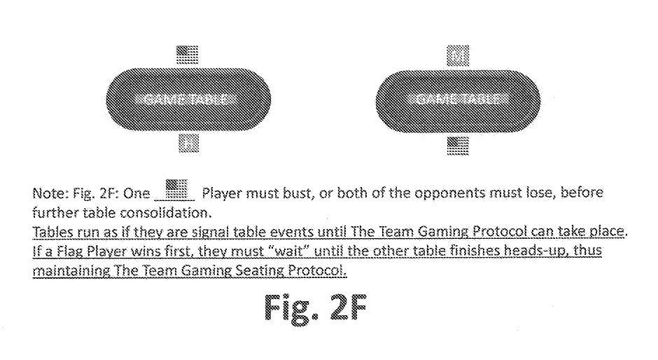

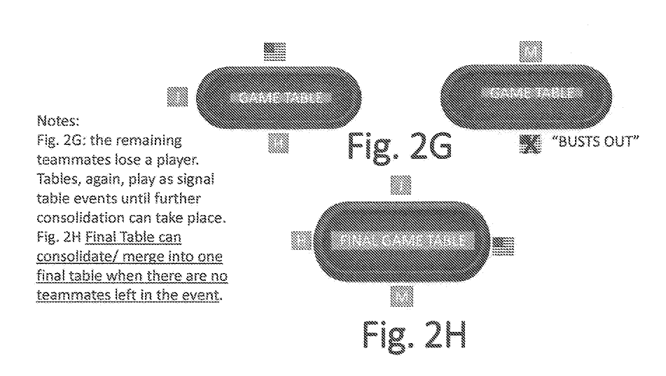

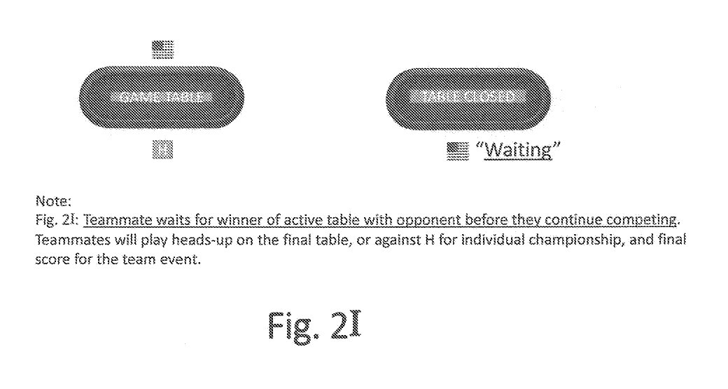

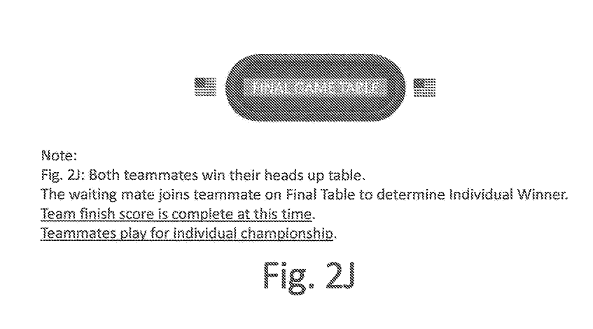

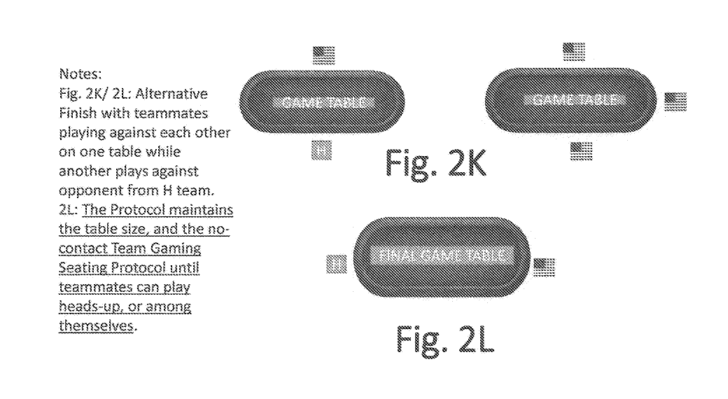

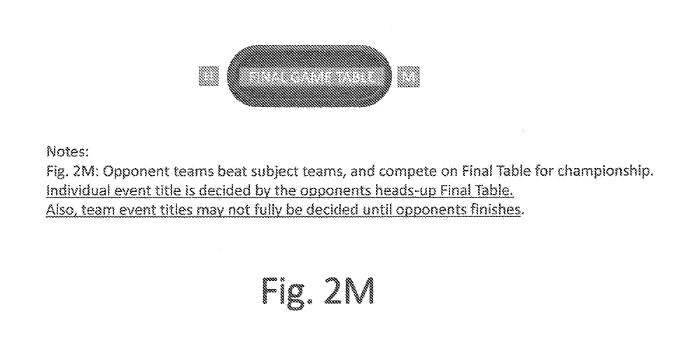

FIG. 2 (FIG. 2A through 2M) are examples of an event with 3 players per team. These examples, like the preceding, show execution of The Seating Protocol that does not allow teammates to play on the same tournament with opponents.

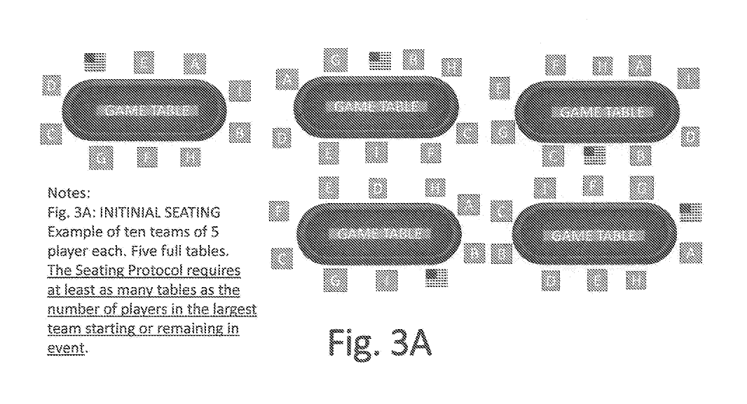

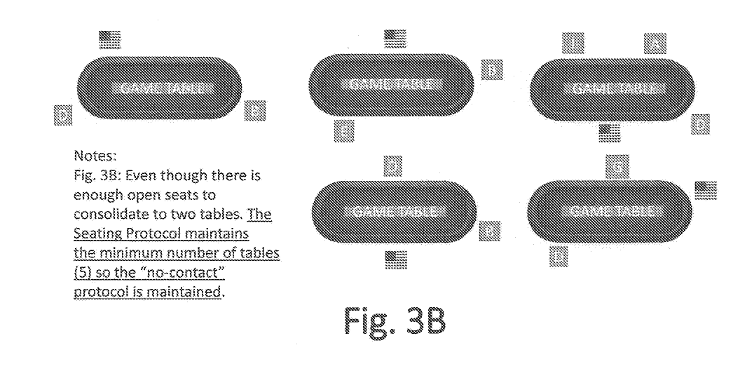

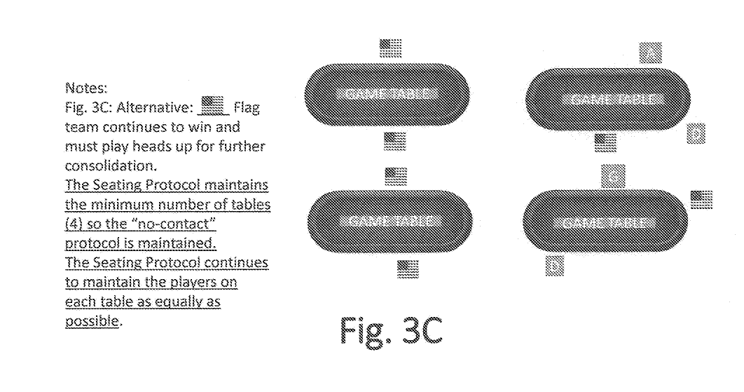

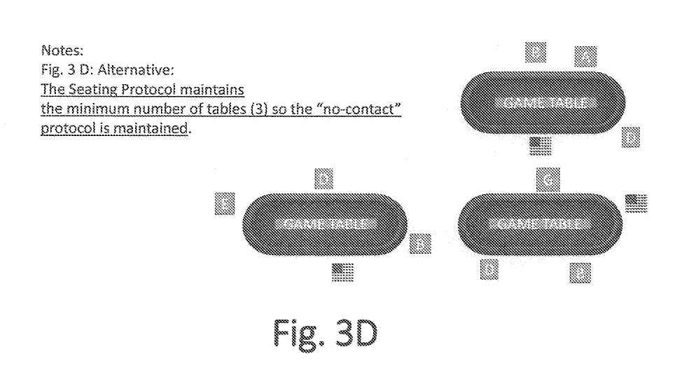

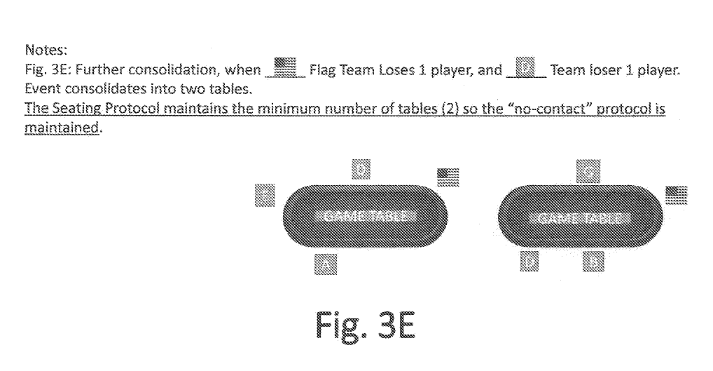

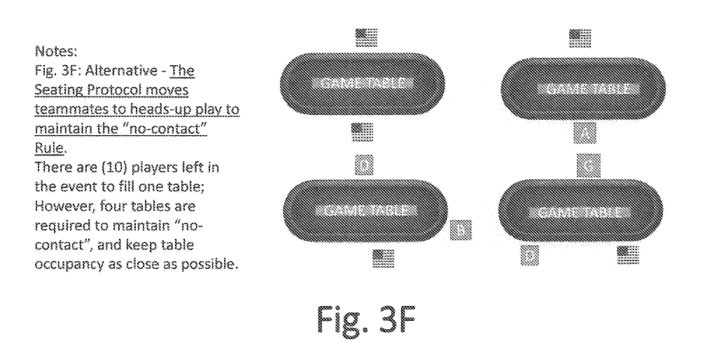

FIG. 3 (FIG. 3A through 3F) are examples of an event with 5 players per team. These examples, like the preceding, also show The Seating Protocol and specific requirements for consolidation. Teammates play together when they can play heads-up, or among themselves for further consolidation. The consolidation ultimately resulting in both individual and team winners.

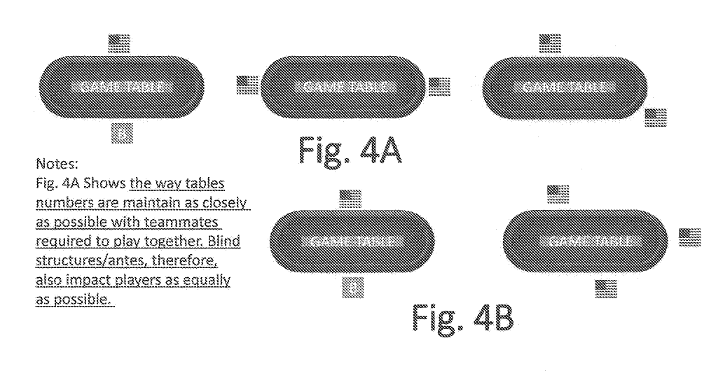

FIG. 4 (FIGS. 4A and 4B) show examples of the Seating Protocols, when there are several teammates remaining in a tournament with one opponent.

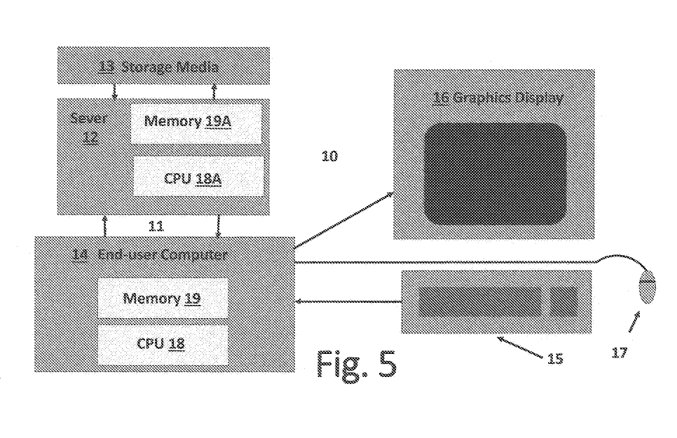

FIG. 5 Shows the Automated Computer System with software to provide the Team Gaming System and Method of creating and executing the, “no-contact”, seating protocol for team events. This computer system is used by tournament directors and other administration to structure and track the execution of seating and table data to facilitate consolidation and expedite tournament team play.

### DETAILED DESCRIPTION OF THE PREFERRED EMBODIMENTS

The present invention includes both a method and a system (FIGS. 1-5) for providing a team gaming seating protocol that prevents the possibility of collusion among teammates in a team gaming tournament. The Team Gaming Seating Consolidation Method, also called herein the “No-Contact” Seating Protocol, provides a seating method that creates a collusion free environment between teams. Thus, using the No-Contact Team Gaming Seating Protocol, tournament directors can assure themselves and players that teams can play “fair and ethical” Team Poker®/team play tournaments.

In the preferred embodiment, the gaming tournament is managed by a live or internet casino, and is a poker gaming tournament; such as, Texas Hold 'em, Seven card Stud Hi/Low, Omaha Hi/Low. However, it should be clearly understood that substantial benefit could be derived from an alternative embodiment of the present invention in which a game other than the aforementioned poker games is played and/or in which the tournament is, or, is not managed by a casino or equivalent.

### DETAILED STEP DESCRIPTION

Description of the “NO-CONTACT” Team Gaming Consolidation Seating Method and System preferred embodiment is demonstrated in the following Protocol Steps:

### Protocol Step 1—Initial Seating

The first step in the method for playing a team gaming tournament is directing the plurality of players to seats that do not have a teammate seated at the table. This initial seating assignment is a random drawing, either manually, or with a computer randomizer. The first step requires that there must be a minimum number of tables in a tournament that is equal to the highest number of players in any team. The initial seating requirement for minimum number of tables remains true until further consolidation requires teammates to play heads-up or together, to maintain the number of players per table as equally as possible.

The preferred embodiment would have the seating protocol built into computerized management system. Players receive their seating assignment at registration, and tournament administration receives consolidation seating protocol direction in a computer device display.

Initial seating could also be executed manually by a random drawing from a structured set of boxes. Initial seating assignments could be drawn from the seats that have tables segregated into groups/boxes. At least one drawing box for every player in the largest team. Each teammate must draw a seat from a separate box, thus ensuring no teammates are on the same table, but otherwise maintaining a totally random draw. All teams seating assignments are fair (“same footing”/“level playing field”) with the “no-contact” team gaming seating protocol.

Referring to FIGS. 1A, 2A, and 3A—These show initial seating examples of three different size tournaments. The initial seating protocol requires that there be at least as many tables as the number of players in the largest team.

Therefore, there must always be, as depicted in Figures, enough tables and seats so that teammates can sit on separate tables; and/or, so teammates do not play on same tables with opponents.

### Protocol Step 2—Seating Consolidation Maintains Minimum Tables

Referring to the FIGS.: 1B, 1D, 2B, 2G, 3B, 3D, and 3E—These are examples of the method of maintaining a minimum number of tables so teammates do not play on the same table with opponents.

### Protocol Step 3—Tables Run as Single Table Tournaments

Referring to FIGS.: 2E and 2F—These are examples of tables running as a single table tournament (STT) until seating protocol permits further consolidation.

The tables play as if they were a single table tournament until further consolidation can take place. The exception to the “like STT”, is that a redistribution of players, by tournament direction, may need to take place to maintain a balance of players per table.

### Protocol Step 4—Seating Protocol Prevents Early Consolidation

Referring to FIGS.: 2C and 2 D—These examples show the method of not allowing tables to consolidate, as they would in a standard gaming tournament, so teammates are not playing on the same table with opponents. The tournament administration process redistributes players as required to maintain the No-Contact Rule.

### Protocol Step 5—Seating Method Requires Mates to Play Heads-Up

Referring to FIGS.: 2K, 3C, and 3F—These examples show the method of having teammates play heads-up, or among themselves, so no teammates play together on same table with opponents.

### Protocol Step 6—Seating Method Requires Teammates to Wait

Referring to FIGS.: 2I—This example shows the protocol of a teammate “waiting” for a winner to advance to final table, maintaining the protocol that teammates never play on the same table with opponents.

Protocol Step 7—when there are No Teammates Left

Referring to FIGS.: 1E, 2H, 2L, and 2M—Method shown in examples of when no teammates remain, table(s) can consolidate in standard manner.

Protocol-Step 8—when Only Teammates are Left

Referring to FIGS.: 1C and 2J—shows examples of the method of allowing teammates to consolidate to one or more tables as necessary when their team is the only one left in tournament.

### Protocol Step 9—Teammates Against One Opponent

Referring to FIGS. 4A and 4B—This protocol step shows how tables' numbers are required to remain as closely equal as possible. Protocol maintains as equitably as possible the blind and ante structures. The table consolidation continues maintaining the balance of players per table and as many tables as required to do so.

### Protocol Step 10—Teammates Playing Together Strategy

Referring to FIGS. 2K, 3C, 3F, 4A, and 4B, the final step protocol: The point in a tournament where teammates are playing heads-up, or with a third teammate provides a unique situation where teammates may “slow play” or “chip dump” as an ethical/fair gaming strategy. These actions are not considered “collusion”, as it is a known strategy, not with opponents at the table, and it may or may not be a good strategy. This point in the tournament provides a “new gaming industry situation”, and “interest point”, where teammates may discuss and decide how to play for the top individual finish positions and individual winner. Tournament prize pools are typically heavily weighted/structured with larger payouts at the top. It is doubtful the teammate's strategy would be to “dump chips” and give up any prize pool position.

At this point in the tournament, the one opponent player has to play heads-up verses the subject teammates and win the same number of chips to win the tournament regardless; therefore, it is just a question of how many teammates will they be required to play heads-up against. Again, it would most likely “not” make sense to give up a ‘finish place payout step’, with its ‘higher prize award’. At this point collusion is not a factor with teammates, and they (the subject teammates) can decide how to play each other. This results in a situation similar to the standard “deal making process” in poker tournaments as director's permit. Therefore, when teammates are in this situation their play speaks for itself and their team strategy.

Thus, the Team Gaming “No-Contact” seating protocol invention, as presented in the steps above, provides a clear method for teams to play poker tournaments without the possibility of collusion. The Figures and steps show the protocol is comprised of methods and a system that assures control and proper execution of said invention.

### Operation

The Team Gaming Seating Protocol can easily be used by Poker Tournament Directors skilled in the business of creating and running tournaments. Said Seating Protocol Invention, as stated, is applicable to any, live or online, game of any size team playing any table card game. A method in a live tournament would require a computer network and live table management. The online method, processes all seating assignment data on computer network.

Using the protocol designed into the team play tournament software, and owner and client inputs, all seating assignments are delivered automatically.

### Computer Network System

The input data is presented and executed in real time so the tournament flows as smoothly and flawlessly as possible, See FIG. 5 (Automated System and Method of creating and executing The Team Gaming Consolidation Seating Protocol). The computer design provides timely information to execute team gaming seating protocol properly.

Referring now to FIG. 5, a system 10 in which embodiments of the present invention may be practice is depicted in a block diagram. A server 12 is coupled to a signal-bearing media in the form of hard disk storage 13 having program instructions for practicing portions of a method in accordance with an embodiment of the present invention that are loaded into a memory 19A and executed by one or more central processing units 18A (CPU). Server 12 is coupled to at least one end-user computer 14 via a network connection 11, which may be an Ethernet connection coupled to routers, bridges, or other terminal equipment for connection to a wide-area network, and thereby to the Internet.

Alternatively, a network connection may be a modem, DSL or cable modem connection coupled to at least one end-user computer 14 for direct connection to the Internet as is typical in hone installations. As such network connection 11 represents a connection to the Internet or other suitable platform for connection to remote systems such as a sever 12.

The present invention users the network depicted in FIG. 5 to remotely deliver a computer gaming tournament in response to activity of a browser executed by a processor (CPU) 18 from memory 19 within at least one end-user 14. The seating assignment for each team/individual is calculated in conformity with a predetermined protocol having dependence of both a number of users on each team and each individual user's performance.

A user having access to end-user computer 14 coupled to network connection 11 playing a gaming tournament is subject to the automated execution the team gaming seating protocol. The various user's actions in the game place them in the position that will have a pre-determined random seating draw within the constraints of no teammates playing together on a table with any opponent play. User's seating assignments and table consolidation controlled in accordance with the team gaming seating protocol.

End-user computer 14 is coupled to a graphical display 16 and input devices such as a keyboard 15 and mouse 17 providing interactivity with the browser grogram in order to provide access to the world-wide-web (WWW). Server 12 is accessed via the grogram of the present invention and may also be accessed directly by browser through the main browser window.

### REFERENCE NUMERALS

10 System
11 Network Connection
12 Server
13 Storage Media
14 End-User Computer
15 Keyboard
16 Graphics Display
17 Mouse
18 End-User CPU
18A Server CPU
19 End-User Memory
19A Server Memory

### CONCLUSION

The Team Gaming “No-Contact” Seating Protocol does not allow teammates on tables with opponents. The “No-Contact” Seating Protocol creates a team gaming tournament table consolidation structure for ethical Team Poker®/poker team play. The protocol resolves the poker industries concern, Reference (1) Ethical Rule 61, on teaming and collusion in poker tournaments. Using this invention there is no potential of collusion among teammates.

The Seating Protocol creates a unique new gaming point where teammates are playing among themselves for individual finish position, and may elect to implement a gaming strategy to finish the tournament. This unique point will most likely be a rare event in most tournaments. However, it offers a significant spectator and player interest point and provides a potential new marketability feature: “One opponent ‘running the gauntlet’ of teammates to win a higher finish position or first place”.

Current field of poker tournament structures does not recognize team play poker as possible for ethical reason. The Team Gaming Seating Protocol provides the opportunity, of what historically is an individual game, to be played ethically and fair with teams. The Team Gaming Seating Protocol provides potential for poker to become even more of a spectator sport with league team play, and it enhances marketability of poker.

While the invention has been particularly shown and described with reference to preferred embodiments thereof, it will be understood by those skilled in the art, that the forgoing and other changes in form and details, may be made therein, without departing form the spirit and scope of the invention. Thus, the scope should be determined by the appended claims and their legal equivalents, and not by the examples given.

1. A team gaming seating method ensuring no possibility of collusion among teammates.

2. A method of claim 1 providing an initial seating process that does not allow teammates on the same table.

3. A method of claim 2 providing a seating protocol requiring teammates to play on separate tables, each as single table tournament (STT), with opponents for the entire tournament event. The method does not allow consolidation of tables or redistribution of players. Individual and team results are calculated without consolidation, or player redistribution.

4. A method of claim 1 providing the structure for teammates to consolidate to distinct and separate tables. Method enables the field of event tables to reduce in number. Method provides a modified random consolidation protocol, when full table capacity can no longer be maintained without teammates.

5. A method in claim 1 reducing tables without teammates from the same team playing together.

6. A process of claim 1 of maintaining a minimum amount of tables as required to ensure teammates are not on the same table with opponent players.

7. A method in claim 1 that provides a modified random initial seating of a plurality of teams of players, within the constraint that the “randomness” not allow multiple teammates on the same table with opponents.

8. A method in claim 1 that provides a random seating draw for seating consolidation, within the constraint that “randomness” does not allow multiple teammates on the same table until they are heads-up or the only players left in the tournament.

9. A method in claim 1 seating protocol that requires tables to play as in a single table tournament until further consolidation can take place. This method requires redistribution of players between tables.

10. A method of claim 1 table consolidation that allows teams to play ethically, and consolidate tables in tournaments, and win prizes both as individuals, and together as teams, using any scoring method.

11. A method of claim 1 providing the capability for multiple teammates to be the last players, and play heads-up, or among each other.

12. A method of claim 1 that provides teams the structure for multiple teammates to play for individual finish positions once no opponents are left in the tournament.

13. A method of claim 1 that provides a seating protocol that requires a teammate to wait for a table to break before consolidation takes place.

14. A method of claim 1 that provides a consolidation option to teams whose multiple teammates are left in a tournament with only one opponent player.

15. A system of seating protocol while playing a team gaming tournament comprising, in combination, the steps of:
Providing a computer network including a sever and at least one end-user computer coupled to said server via a network connection;
Wherein said end-user computer has a graphical display portion adapted to display a browser window;
Displaying a game of a gaming tournament in said bowser window;
Permitting a game of a plurality of users to be seated in said game of said gaming tournament;
Forming a plurality of teams of at least one user from said plurality of users entered in said gaming tournament;
Sending user input form said plurality of users to said server; and
Calculating an initial seating assignment and subsequently during table consolidation for each of said plurality of teams in a gaming tournament conforming to and implementing the team gaming seating protocol. Using the predetermined seating formula having dependence on both a number of users on each of said plurality of teams, and performance of each said plurality of teams, and a performance of each said plurality of users for seating re-assignment and table consolidation.

16. A server system providing a computer team gaming tournament seating protocol method, comprising, in combination:
A memory for storing program instructions and data; a processor coupled to said memory for executing said program instruction, wherein said program instructions include program instructions for:
Display a browser window;
Display seating protocol in team gaming tournament in said browser window;
Permitting a plurality of users to be seated in said game of said gaming tournament;
Forming and seating a plurality of teams of at least one user from said plurality of users entered in said gaming tournament;
Receiving indication of user input from a plurality of user computers, and Calculation of seating assignments of each said plurality of teams in said gaming tournament in conformity with a predetermined formula having dependence on both a number of users on each said plurality of teams and a performance of each said plurality of users.
